(19) United States
(12) Patent Application Publication
(10) Pub. No.: US 2006/0038803 A1
(43) Pub. Date: Feb. 23, 2006

(54) LED control method and structure therefor

(75) Inventors: Roger L. Miller, Palos Verdes Estates, CA (US); Robert E. Houf, Tempe, AZ (US); Ronald G. Vinsant, Mountain View, CA (US)

Correspondence Address: Mr. Jerry Chruma;Semiconductor Components Industries, L.L.C., Patent Administration Dept-MD/A700, P.O. Box 62890, Phoenix, AZ, 85082-2890, US

(73) Assignee: Semiconductor Components Industries, LLC

(21) Appl. No.: 10/923,613

(22) Filed: Aug. 20, 2004

(51) Int. Cl. G09G 5/00

(52) U.S. Cl. 345/204

(57) ABSTRACT

In one embodiment, a plurality of LEDs are connected in series. A substantially constant current is applied to the LEDs. An amount of the current that flows through each LED is selectively controlled to provide light of a desired color and intensity.

### BACKGROUND OF THE INVENTION

The present invention relates, in general, to electronics, and more particularly, to methods of forming semiconductor devices and structure.

In the past, the semiconductor industry utilized various methods and structures to drive light emitting diodes (LEDs). Typically, each LED was connected to a voltage source and a separate current flowed through each LED. A typical implementation of such an LED display is illustrated in FIG. 1. A color LCD display typically had three different color LEDs such as a red LED 102, a blue LED 103, and a green LED 104. A voltage source 100 supplied a voltage that was applied to an anode of each LED including LEDs 102, 103, and 104. Transistors 106, 107, and 108 were turned-on to provide a separate current that flowed through each respective LED 102, 103, and 104. One problem with the prior LED driver circuits was accurately controlling the light emitted by each LED. The forward voltage drop across each LED generally was large and could be on the order of four to five volts (4-5 V). The amount of the forward voltage drop was very sensitive to the temperature of the LEDs. As the temperature of each LED increased during operation, the forward voltage increase and the current flow through each LED also correspondingly decreased thereby varying the light output of the LED. Consequently the color emitted by the LED display changed during the operation.

Accordingly, it is desirable to have a method of controlling an LED that provides accurate control of the LED drive current, and that provides an accurate control of the color emitted by the display.

### BRIEF DESCRIPTION OF THE DRAWINGS

FIG. 1 schematically illustrates a typical prior art LED display driver and system;

FIG. 2 schematically illustrates a portion of an embodiment of an LED display system in accordance with the present invention;

FIG. 3 schematically illustrates an alternate embodiment of a portion of the LED display system of FIG. 2 in accordance with the present invention; and

FIG. 4 illustrates an enlarged plan view of a portion of a semiconductor die that includes a portion of the LED display system of FIG. 2 in accordance with the present invention.

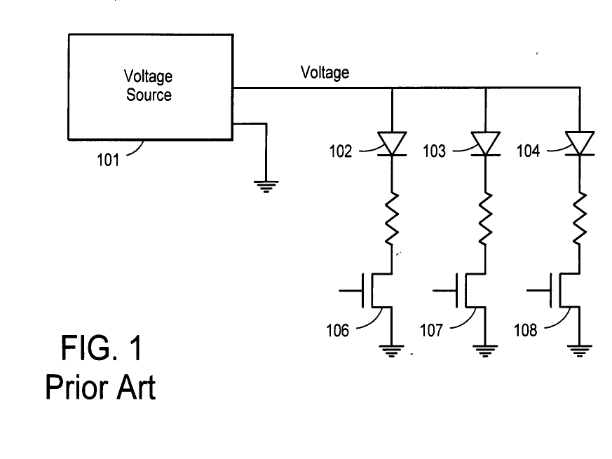

For simplicity and clarity of illustration, elements in the figures are not necessarily to scale, and the same reference numbers in different figures denote the same elements. Additionally, descriptions and details of well-known steps and elements are omitted for simplicity of the description. As used herein current carrying electrode means an element of a device that carries current through the device such as a source or a drain of an MOS transistor or an emitter or a collector of a bipolar transistor, and a control electrode means an element of the device that controls current through the device such as a gate of an MOS transistor or a base of a bipolar transistor. Although the devices are explained herein as certain N-channel or P-Channel devices, a person of ordinary skill in the art will appreciate that complementary devices are also possible in accordance with the present invention.

### DETAILED DESCRIPTION OF THE DRAWINGS

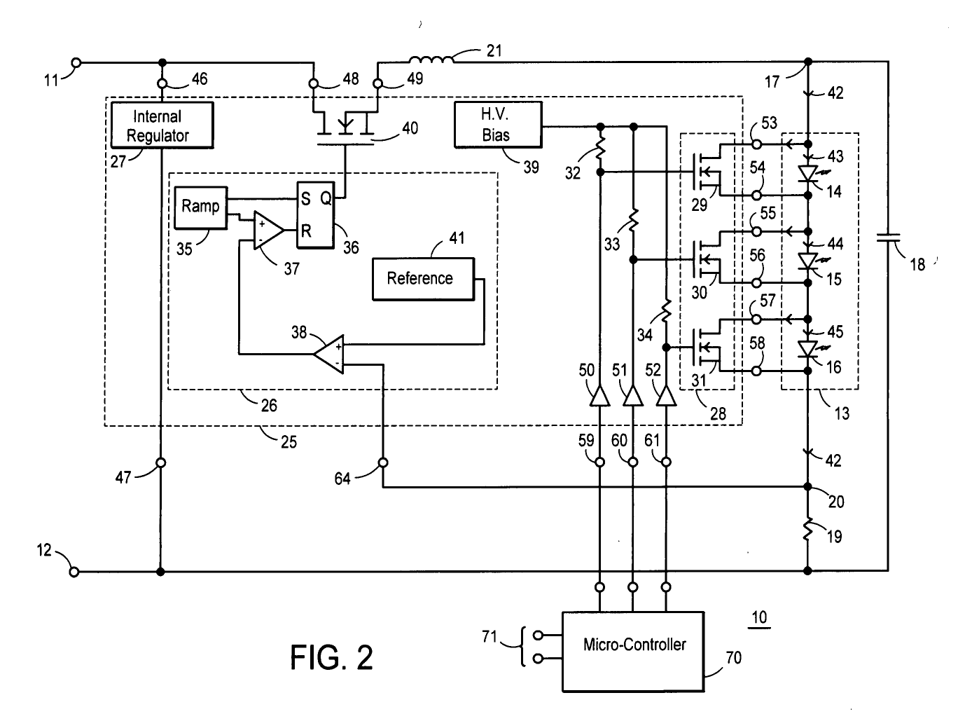

FIG. 2 schematically illustrates an embodiment of a portion of a light emitting diode (LED) display system 10 that includes an LED controller 25 that accurately controls the LEDs of system 10. System 10 includes a plurality of LEDs including a first LED 14, second LED 15, and a third LED 16 that are connected together to form a series connected group or string of LEDs 13. In most embodiments, LEDs 14, 15, and 16 emit different light wavelengths in order to form a multi-color display, for example LED 14 may be a red LED, LED 15 may be a green LED, and LED 16 may be a blue LED. Typically, LEDs 13 are formed in a single LED package, but may be other configurations in other embodiments. Controller 25 is configured to form an LED drive current 42 that is applied to series connected LEDs 13 and to maintain the value of current 42 substantially constant. However, as is well known in the art there are always minor variances that prevent current 42 from being exactly constant. It is well established in the art that variances of up to about ten percent (10%) are regarded as reasonable variances from the ideal goal of exactly constant. Additionally, controller 25 is configured to selectively control an amount of current 42 that flows through any individual one of LEDs 14-16 separately from the amount of current flowing through the other LEDs of LEDs 14-16 in order to control the intensity of the light and the color of the light emitted by LEDs 13.

System 10 receives power from an external source (not shown) between a power input 11 and a power return 12. Typically the voltage applied between input 11 and return 12 is a DC voltage. Controller 25 receives the input voltage and forms an LED voltage on a voltage node 17 and applies current 42 to LEDs 13. In addition to controller 25, system 10 typically includes an energy storage inductor 21 and an energy storage capacitor 18 that assist in forming the LED voltage. Current 42 also flows through a current sense resistor 19 and forms a current sense signal at a node 20 that is received on a current sense input 64 of controller 25. Resistor 19 is connected in series with LEDs 13 in order to receive current 42. A micro-controller 70 has a set of user inputs 71 that are used provide control signals to controller 25 to assist in selecting the color and intensity of the light emitted by LEDs 13.

Controller 25 typically includes a current controller 26, a current steering circuit 28, an internal regulator 27, and a power switch or power transistor 40. Internal regulator 27 provides an operating voltage for operating the elements within controller 25 such as the elements within current controller 26. Regulator 27 is connected between a voltage input 46 and a voltage return 47 of controller 25 in order to receive the input voltage from input 11.

In one embodiment current controller 26 is a current mode PWM controller but may be other types of current controllers that can maintain the value of current 42 substantially constant. In this embodiment, controller 26 includes a reference voltage generator or reference 41, a high voltage bias generator or HV Bias 39, a plurality of buffers 50-52, a plurality of bias resistors 32-34, a current control amplifier 38, a ramp comparator 37, a ramp generator or ramp 35, and a PWM latch 36. Reference 41 forms a reference voltage on an output of reference 41. Ramp 35 typically provides a clock signal on a first output of ramp 35 and a voltage ramp on a second output of ramp 35. The clock signal or clock is used to set latch 36 and began enabling transistor 40 to conduct current from input 11 to LEDs 13 and capacitor 18. Current steering circuit 28 includes a plurality of current switches that are used to modulate the amount of current 42 that flows through each of LEDs 14, 15, and 16 in order to control the color and the intensity of the light that is generated by LEDs 13 as will be seen further hereinafter. Bias 39 generates a high voltage bias that is used to assist in operating circuit 28 as will be seen further hereinafter.

The clock output of ramp 35 sets latch 36 and drives the Q output high to thereby driving the PWM control signal high to begin enabling transistor 40. Transistor 40 conducts current to store energy in inductor 21, charge capacitor 18 to the LED voltage, and provide current 42 to LEDs 13. The value of the forward voltage drop across each of LEDs 14, 15, and 16 varies during the operation of LEDs 13. As the forward voltage drop varies, controller 25 regulates the value of current 42 to remain substantially constant in order to maintain the color and intensity of the light emitted by LEDs 14-16, however, the value of the voltage on node 17 varies as the value of the forward voltage drop across LEDs 13 varies. Amplifier 38 receives the reference voltage and the current sense signal and responsively forms an error signal that is representative of a difference between the value of current 42 and a desired value of current 42. It should be noted that the current sense signal may have to be biased in order to adjust the center point of the value of the current sense signal to a value that is consistent with the value of the reference voltage on the output of reference 41. For example, the current sense signal may be received by an amplifier that adds a common mode voltage to the current sense signal. Alternately, the value of the reference voltage may be selected to be consistent with the operating range of the current sense signal. Comparator 37 receives the ramp signal and the error signal and responsively drives the output of comparator 37 high to reset latch 36 when the value of the ramp signal has reached the value of the error signal. Resetting latch 36 drives the Q output, thus the PWM control signal, low and begins disabling transistor 40 in order to keep the value of current 42 substantially constant.

Circuit 28 is used to selectively control the amount of current 42 that separately flows through each of LEDs 14-16 in order to selectively control the amount or intensity of the light emitted by each individual LED of LEDs 14-16 and thereby the resulting color of the light emitted by LEDs 13. Circuit 28 includes a first switch or transistor 29 that is connected in parallel with LED 14, a second switch or transistor 30 that is connected in parallel with LED 15, and a third switch or transistor 31 that is connected in parallel with LED 16. Each of transistors 29, 30, and 31 are switched on and off at a particular duty cycle in order to selectively control the amount of current 42 that flows through respective LEDs 14, 15, and 16. As each transistor is switched on, the transistor shunts current 42 through the transistor and prevents current 42 from flowing through the respective LED. When the transistor is off, all of current 42 flows through the respective LED. Since current 42 is substantially constant, each time a transistor is off, the intensity of the light emitted by the respective LED is constant and does not substantially vary because the value of current 42 does not substantially vary. Thus after transistor 29 is enabled, a current 43 is substantially zero but current 42 remains substantially constant and flows through transistor 29. After transistor 30 is enabled, a current 44 is substantially zero but current 42 remains substantially constant and flows through transistor 30. After transistor 31 is enabled, a current 45 is substantially zero but current 42 remains substantially constant and flows through transistor 31. Additionally, when the same current flows through each LED of LEDs 14-16, thus, thereby improving the control of the emitted light. Thus, it can be seen that selectively enabling and disabling transistors 29, 30, and 31 selectively controls the amount of current 42 that flows through respective LEDs 14, 15, and 16. The length of the off-time of each of transistors 29, 30, and 31 controls the intensity of the light emitted by respective LEDs 14, 15, and 16, thus, the color of the light emitted by LEDs 13. For example, if transistor 29 is switched with a ten percent (10%) duty cycle and transistor 30 is switched with a fifty percent (50%) duty cycle and transistor 31 is switched with a twenty-five percent (25%) duty cycle LEDs 13 will emit a first color at a first intensity. Changing the ratios between the duty cycles of each of LEDs 14-16 changes the color. Changing all the duty cycles but maintaining the same ratio between the duty cycles changes the intensity of the light but not the color of the light emitted by LEDs 13. For example, multiplying the duty cycles of each of transistors 29, 30, and 31 by a factor of two (2) increases the intensity but doesn't change the color. However, changing the duty cycle of transistor 30 from fifty percent (50%) to forty percent (40%) while leaving the duty cycles of transistors 29 and 31 at ten percent (10%) and twenty-five percent (25%), respectively, changes the color. In order to establish the duty cycle of transistors 29-31, controller 25 receives control signals on a plurality of control inputs including a first control input 59, a second control input 60, and a third control input 61. Typically, micro-controller 70 receives an input from a user on user inputs 71 and decodes them to determine the duty cycles of transistors 29-31. Micro-controller 70 then drives control inputs 59-61 with the control signals in order to provide the desired duty cycles for transistors 29-31. Controller 25 receives the control signals and responsively enables and disables respective transistors 29, 30, and 31. For example, when any of control inputs 59-61 is high the respective transistor is enabled and when any of control inputs 59-61 is low the respective transistor is disabled. Buffers 50, 51, and 52 receive the control signals and control the gates of respective transistors 29, 30, and 31. When the output of any of buffers 50-52 go high they enable respective transistors 29, 30, and 31 by allowing resistors 32, 33, and 34 to pull the gates of respective transistors 29, 30, and 31 to the high voltage on the output of HV bias 39 thereby enabling the respective transistors. The value of the voltage on the output of bias 39 is selected to be high enough to ensure that any of transistors 29-31 will be enabled for all combinations of transistors 29-31 being enabled. For example if transistors 29, 30, and 31 are disabled, LEDs 14, 15, and 16 are turned-on and the source of transistor 29 is at a voltage that is close to the voltage on node 17. In order to enable transistor 29, the gate of transistor 29 should be pulled to a voltage that is greater than the voltage on the source plus the threshold voltage of transistor 29. That higher voltage typically is greater than the voltage on node 17. In one embodiment, bias 39 is a charge pump that is connected between the output of regulator 27 and return 47 to receive the internal operating voltage and responsively generate a voltage that is greater than the value of the voltage on node 17. Such charge pumps are well known to those skilled in the art.

In order to provide the functionality described for system 10, input 46 is connected to input 11, to a first current carrying electrode of transistor 40, and to an input terminal of regulator 27. A second terminal of regulator 27 is connected to return 47. A second current carrying electrode of transistor 40 is connected to a first terminal of inductor 21 which has a second terminal connected to node 17, and a first terminal of capacitor 18. An anode of LED 14 is connected to node 17 and to input 53 of controller 25. A cathode of LED 14 is commonly connected to an anode of LED 15, and to inputs 54 and 55 of controller 25. A cathode of LED 15 is commonly connected to an anode of LED 16, and to inputs 56 and 57 of controller 25. A cathode of LED 16 is connected to input 58 of controller 25, input 64 of controller 25, and a first terminal of resistor 19. A second terminal of resistor 19 is connected to a second terminal of capacitor 18, to return 47, and to return 12. A non-inverting input of amplifier 38 is connected to the output of reference 41. An inverting input of amplifier 38 is connected to input 64 and an output of amplifier 38 is connected to an inverting input of comparator 37. A non-inverting input of comparator 37 is connected to the ramp output of ramp 35 and an output of comparator 37 is connected to the reset input of latch 36. The clock output of ramp 35 is connected to the set input of latch 36 which has a Q output connected to a gate of transistor 40. Although not show for clarity of the drawings, typically an input of bias 39 is connected to the output of regulator 27, a common terminal of bias 39 is connected to return 47, and an output of bias 39 is connected to a first terminal of resistors 32-34. Transistor 29 has a drain connected to input 53, a source connected to input 54, and a gate commonly connected to a second terminal of resistor 32 and an output of buffer 50. An input of buffer 50 is connected to input 59. Transistor 30 has a drain connected to input 55, a source connected to input 56, and a gate commonly connected to a second terminal of resistor 33 and an output of buffer 51. An input of buffer 51 is connected to input 60. Transistor 31 has a drain connected to input 57, a source connected to input 58, and a gate commonly connected to a second terminal of resistor 34 and an output of buffer 52. An input of buffer 52 is connected to input 61.

In most embodiments, controller 25 is formed on a semiconductor die by well-known semiconductor processing techniques. In some embodiments, transistor 40 may be external to the semiconductor die on which the remainder of controller 25 is formed. Additionally, in some embodiments circuit 28, bias 39, buffers 50-52, and resistors 32-34 may be external to the semiconductor die on which the remainder of controller 25 is formed. Those skilled in the art will realize that current controller 26 may have other embodiments in addition to the embodiment illustrated in FIG. 2 as long as the value of current 42 is controlled to be substantially constant.

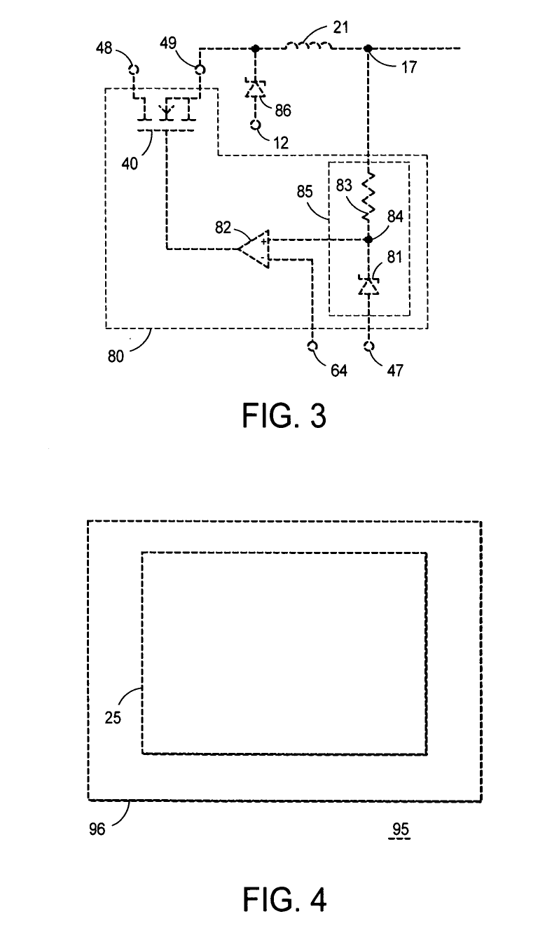

FIG. 3 schematically illustrates a current controller 80 that is an alternate embodiment of controller 26 that is explained in the description of FIG. 2. Current controller 80 includes a voltage reference generator or reference 85 and a current control comparator 82. Reference 85 includes a zener diode 81 that is connected to the voltage on node 17 by a resistor 83 and forms a reference voltage at a node 84. Comparator 82 receives the reference voltage and the current sense signal and responsively drives transistor 40 to maintain the value of current 42 substantially constant. A Schottky diode 86 is used to discharge the stored energy of inductor 21. Controllers similar to controller 80 are often referred to as hysteretic controllers.

In order to provide the functionality described for FIG. 3, resistor 83 has a first terminal connected to node 17, and a second terminal commonly connected to node 84, a cathode of diode 81, and a non-inverting input of comparator 82. An anode of diode 81 is connected to return 47. An inverting input of comparator 82 is connected to input 64 while an output of comparator 82 is connected to the gate of transistor 40.

FIG. 4 schematically illustrates an enlarged plan view of a portion of an embodiment of a semiconductor device 95 that is formed on a semiconductor die 96. Controller 25 is formed on die 96. Die 96 may also include other circuits that are not shown in FIG. 4 for simplicity of the drawing. Controller 25 and device 95 are formed on die 96 by semiconductor manufacturing techniques that are well known to those skilled in the art.

In view of all of the above, it is evident that a novel device and method is disclosed. Included, among other features, is controlling the current through a plurality of series connected LEDs to be substantially constant. Additionally an amount of the current that flows through each of the LEDs is selectively controlled for each individual LED.

While the invention is described with specific preferred embodiments, it is evident that many alternatives and variations will be apparent to those skilled in the semiconductor arts. More specifically the invention has been described for a particular N-channel MOS transistors, although the method is directly applicable to other MOS transistors, bipolar transistors, as well as BiCMOS, metal semiconductor FETs (MESFETs), HFETs, and other transistor structures. Additionally, the word “connected” is used throughout for clarity of the description, however, it is intended to have the same meaning as the word “coupled”. Accordingly, “connected” should be interpreted as including either a direct connection or an indirect connection.

1. A method of forming an LED controller comprising:
configuring the LED controller to form an LED drive current for a plurality of series connected LEDs and to maintain the LED drive current substantially constant; and
configuring the LED controller to selectively control an amount of the LED drive current that passes through any one LED of the plurality of series connected LEDs separately from other LEDs of the plurality of series connected LEDs.

2. The method of claim 1 wherein configuring the LED controller to selectively control the amount of the LED drive current that passes through any one LED of the plurality of series connected LEDs separately from other LEDs of the plurality of series connected LEDs includes configuring the LED controller to modulate an amount of the LED drive current that passes through the one LED.

3. The method of claim 1 wherein configuring the LED controller to selectively control the amount of the LED drive current that passes through one LED of the plurality of series connected LEDs separately from other LEDs of the plurality of series connected LEDs includes configuring the LED controller to shunt a portion of the LED drive current through a plurality of switches connected in parallel with the plurality of series connected LEDs.

4. The method of claim 1 wherein configuring the LED controller to selectively control the amount of the LED drive current that passes through one LED of the plurality of series connected LEDs separately from other LEDs of the plurality of series connected LEDs includes configuring the LED controller to shunt a first portion of the LED drive current through a first switch connected in parallel with a first LED of the plurality of series connected LEDs.

5. The method of claim 4 further including configuring the LED controller to shunt a second portion of the LED drive current through a second switch connected in parallel with a second LED of the plurality of series connected LEDs, and shunting a third portion of the LED drive current through a third switch connected in parallel with a third LED of the plurality of series connected LEDs.

6. The method of claim 5 configuring the LED controller to form the first portion of the LED drive current to be different than the second portion of the LED drive current and to form the third portion of the LED drive current to be different than the second portion of the LED drive current and different than the first portion of the LED drive current.

7. The method of claim 1 wherein configuring the LED controller to apply a drive current to a plurality of series connected LEDs and to maintain the drive current substantially constant includes configuring the LED controller to receive a current sense signal that is representative of the drive current and responsively control the drive current to a substantially constant value.

8. The method of claim 7 wherein configuring the LED controller to receive the current sense signal that is representative of the drive current and responsively control the drive current to the substantially constant value includes coupling a PWM controller to receive the current sense signal and responsively control a power switch to control the LED drive current to the substantially constant value.

9. The method of claim 7 wherein configuring the LED controller to receive the current sense signal that is representative of the drive current and responsively control the drive current to the substantially constant value includes configuring the LED controller to use a current mode PWM controller to control the drive current.

10. An LED controller comprising:
a current controller operably coupled to receive a current sense signal that is representative of a drive current through a plurality of series connected LEDs and to responsively maintain the drive current substantially constant; and
a plurality of switches configured to receive LED control signals and selectively control an amount of the drive current that flows through each LED of the plurality of series connected LEDs.

11. The LED controller of claim 10 wherein the plurality of switches shunt a portion of the drive current away from the plurality of series connected LEDs.

12. The LED controller of claim 10 wherein the plurality of switches configured to receive the LED control signals includes a first switch coupled in parallel with a first LED of the plurality of series connected LEDs and a second switch coupled in parallel with a second LED of the plurality of series connected LEDs wherein the first switch is coupled to control a first amount of the drive current through the first LED and the second switch is coupled to control a second amount of the drive current through the second LED.

13. The LED controller of claim 12 wherein the LED controller is configured to form the first amount different than the second amount.

14. The LED controller of claim 12 wherein the LED controller is operably coupled to receive the LED control signals and form the first amount and the second amount.

15. The LED controller of claim 10 further including a plurality of LED control inputs configured to receive a plurality of LED control signals.

16. A method of controlling LEDs comprising:
coupling a plurality of LEDs in series;
applying a drive current to the plurality of LEDs and maintaining the drive current substantially constant; and
selectively controlling an amount of the drive current that flows through each LED of the plurality of LEDs.

17. The method of claim 16 wherein selectively controlling the amount of the drive current that flows through each LED of the plurality of LEDs includes controlling a first amount of the drive current to flow through a first LED of the plurality of LEDs and controlling a second amount of the drive current to flow through a second Led of the plurality of LEDs.

18. The method of claim 16 wherein selectively controlling the amount of the drive current that flows through each LED of the plurality of LEDs includes shunting a first amount of the drive current away from a first LED of the plurality of LEDs, and shunting a second amount of the drive current away from a second LED of the plurality of LEDs.

19. The method of claim 16 wherein applying the drive current to the plurality of LEDs and maintaining the drive current substantially constant includes forming a current sense signal that is representative of the drive current and using the current sense signal to maintain the drive current substantially constant.

20. The method of claim 16 wherein applying the drive current to the plurality of LEDs and maintaining the drive current substantially constant includes pulse width modulating an on-time of a power switch that is coupled to form the drive current.
